(19) United States
(12) Patent Application Publication
(10) Pub. No.: US 2010/0048094 A1
(43) Pub. Date: Feb. 25, 2010

(54) SIMULATED EYE FOR USE IN TOY

(75) Inventors: TE-HUA LEE, Tu-Cheng (TW); CHE CHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HONG HAI PRECISION INDUSTRY CO., LTD., Tu-Cheng (TW)

(21) Appl. No.: 12/539,569

(22) Filed: Aug. 11, 2009

(30) Foreign Application Priority Data
Aug. 25, 2008 (CN) 200810304173.7

(51) Int. Cl. A63H 3/38; G02F 1/01

(52) U.S. Cl. 446/389; 359/288

(57) ABSTRACT

A simulated eye is provided. The simulated eye comprises a main body comprising a front surface. An area is formed on the front surface for simulating pupil portion of an eye. A first ring portion is formed on the front surface and surrounds the area. The first ring portion is covered with a layer of reversible thermochromic material.

### BACKGROUND

1. Technical Field

The present disclosure relates to simulated eyes and, more particularly, to a simulated eye for use in combination with a toy which can produce an effect of pupils dilating and contracting.

2. Description of Related Art

Dolls and plush toys have for many years been a popular toy category. Because the eye construction represents an important factor in the success of dolls and plush figures, practitioners in the art have endeavored to provide a variety of simulated eyes. It is known that pupils dilate in a dark environment and contract in a well-lit environment. It is of interest to provide simulated eyes for use in combination with toys that can produce an effect of pupils dilating and contracting.

### BRIEF DESCRIPTION OF THE DRAWINGS

FIG. 1 is an isometric view of a simulated eye for use in combination with a toy in accordance with an exemplary embodiment.

FIG. 2 is another isometric view of the simulated eye of FIG. 1, which shows the back portion of the simulated eye.

FIG. 3 is another isometric view of the simulated eye of FIG. 1, which shows a round area and a ring portion have the same color.

### DETAILED DESCRIPTION

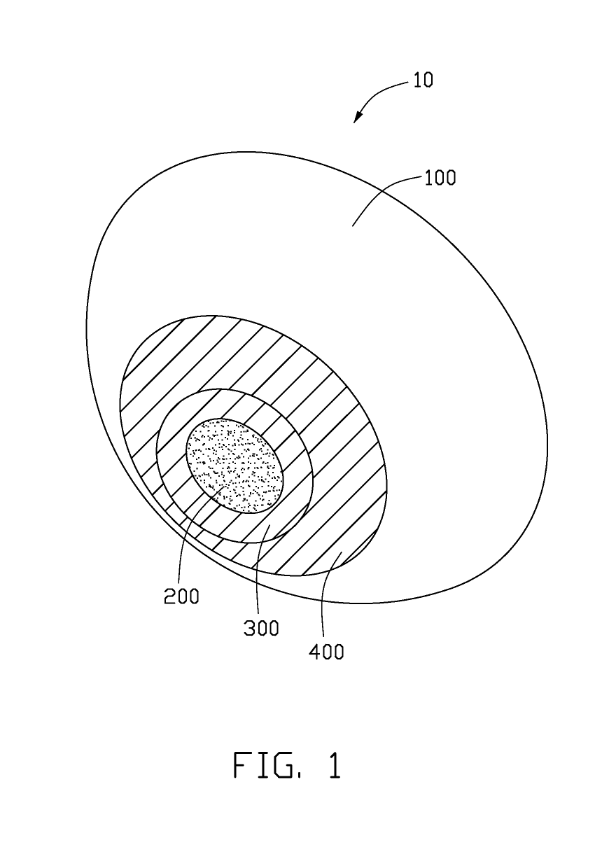

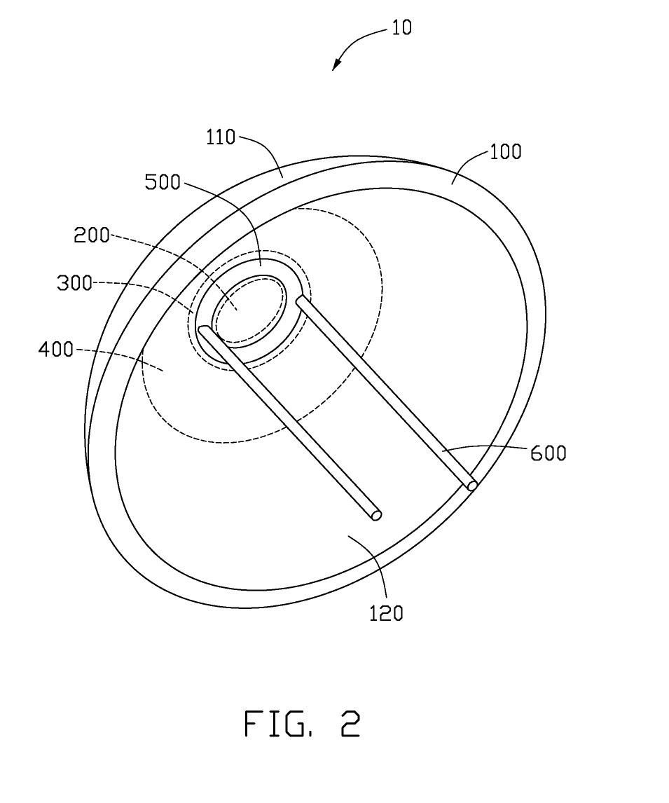

FIGS. 1 and 2 show a simulated eye 10 for use in combination with a toy (not shown). The simulated eye 10 comprises a main body 100. In an exemplary embodiment, the main body 100 is in the shape of a hollow half sphere which includes a convexly curved front surface 110 and a hollow space 120. However, the shape of the main body 100 is not limited thereto and may be shaped in other suitable forms, which will be better understood from the following description.

An area 200 with a first color is formed on the front surface 100 and is used for simulating pupil portion of an eye. In the present embodiment, the area 200 is substantially round and is formed by applying a layer of material with the first color on the front surface 11 0. The first color is golden in appearance and may be other suitable colors.

A first ring portion 300 is formed on the front surface 100 and surrounds the area 200. In the present embodiment, the first ring portion 300 is formed by applying a layer of material with the first color on the front surface 11 0. The first ring portion 300 is covered by a layer of reversible thermochromic material.

A second ring portion 400 is formed on the front surface 100 and surrounds the first ring portion 300. In the present embodiment, the second ring portion 400 is formed by applying a layer of material with a second color on the front surface 11 0. The second color is different from the first color.

In the present embodiment, when the temperature of the first ring portion 300 is below a predetermined value, the layer of reversible thermochromic material has the same color as the second ring portion. When the temperature of the first ring portion 300 is above the predetermined value, the layer of reversible thermochromic material becomes transparent.

When the layer of reversible thermochromic material is transparent, it is the area 200 and the first ring portion 300 that is shown to be the first color, which gives viewers a feel that the area 200 becomes larger. When the layer of reversible thermochromic material recovers to be the second color, it is the area 200 that is shown to be the first color. As a result, the changes of area having the first color will cause the viewers feel that the simulated eye 10 can expand and contract its pupil portion.

In another embodiment, when the temperature of the first ring portion 300 is below a predetermined value, the layer of reversible thermochromic material has the same color as the second ring portion. When the temperature of the first ring portion 300 is above the predetermined value, the layer of reversible thermochromic material changes from the second color to the first color. In this embodiment, the reversible thermochromic material may be CuHg1₄ or Ag₂Hg1₄.

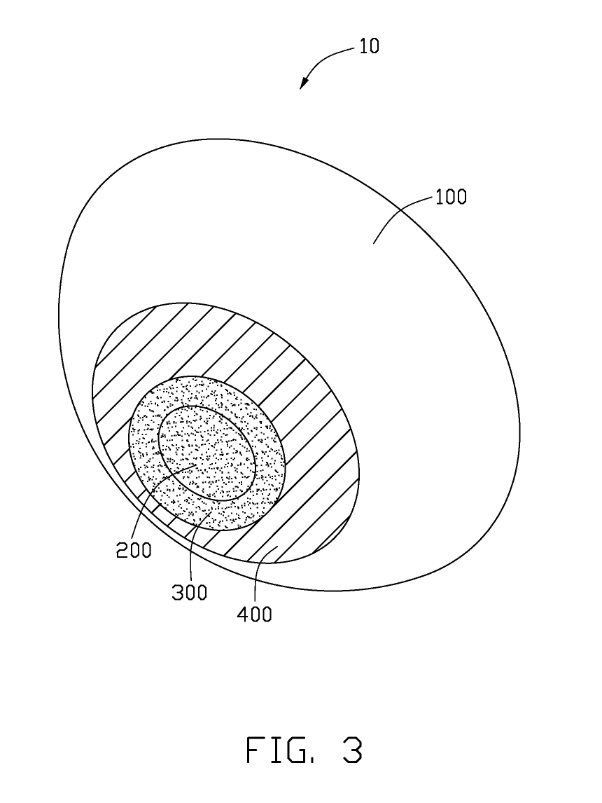

Referring to FIG. 3, together with FIG. 2, in the present embodiment, the simulated eye 10 also comprises a heating element 500 placed within the hollow space 120. The heating element 500 may be a resistance wire and can be connected to a power source (not shown) via two power cables 600. The heat produced from the heating element 500 is conducted to the layer of thermochromic material via the main body 100.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A simulated eye for use in combination with a toy, comprising:
a main body comprising a front surface;
an area formed on the front surface for simulating a pupil portion of an eye having a first color; and
a first ring portion formed on the front surface surrounding the area, wherein the first ring portion is covered with a layer of reversible thermochromic material.

2. The simulated eye according to claim 1, further comprising a second ring portion formed on the front surface, the second ring portion surrounding the first ring portion and having a second color different from the first color.

3. The simulated eye according to claim 2, wherein the first ring portion has the same color as the area, and the layer of reversible thermochromic material has the same color as the second ring portion and becomes transparent when the temperature of the first ring portion increases to a predetermined value.

4. The simulated eye according to claim 2, wherein the layer of reversible thermochromic material has the same color as the second ring portion and changes to the first color when the temperature of the first ring portion increases to a predetermined value.

5. The simulated eye according to claim 1, wherein the main body is hollow and comprises a hollow area.

6. The simulated eye according to claim 5, further comprising a heating element disposed within the hollow area for heating the layer of reversible thermochromic material.

7. The simulated eye according to claim 1, wherein the reversible thermochromic material is CuHg1₄.

8. The simulated eye according to claim 1, wherein the reversible thermochromic material is Ag₂Hg1₄.

9. The simulated eye according to claim 1, wherein the front surface of the main body is convexly curved.

10. The simulated eye according to claim 9, wherein the main body is a hollow half sphere.
